(19) United States
(12) Patent Application Publication
(10) Pub. No.: US 2026/0268060 A1
(43) Pub. Date: Sep. 10, 2026

(54) METHOD AND SYSTEM FOR LAYOUT OPTIMIZATION

(71) Applicant: Samsung Electronics Co., Ltd., Suwon-si (KR)

(72) Inventors: Minchul Park, Suwon-si (KR); Jihye Lee, Suwon-si (KR); Seongryeol Kim, Suwon-si (KR); Younggu Kim, Suwon-si (KR); Hyunjae Jang, Suwon-si (KR)

(21) Appl. No.: 19/390,950

(22) Filed: Nov. 17, 2025

(30) Foreign Application Priority Data
Mar. 5, 2025 (KR) 10-2025-0028377

(51) Int. Cl. G06F 30/398

(52) U.S. Cl. CPC G06F 30/398

(57) ABSTRACT

The layout optimization method may include defining information of a layout, deriving vulnerabilities of the layout by a vulnerability detector including a neural network model portion, performing optimization of the layout by an optimization module portion, and generating a new layout pattern by a layout database generator and updating the generated new layout pattern in a layout database.

### CROSS-REFERENCE TO RELATED APPLICATION(S)

This application is based on and claims priority under 35 U.S.C. §119 to Korean Patent Application No. 10-2025-0028377, filed on Mar. 5, 2025, in the Korean Intellectual Property Office, the disclosure of which is incorporated by reference herein in its entirety.

### BACKGROUND

This specification relates to a method and system for layout optimization, and more particularly, to a method and system for large-scale layout optimization that takes into account spatial and physical interactions among a plurality of layouts.

There are issues with defects and performance problems caused by a plurality of physical interactions due to layout, and because local layout changes interact with various characteristics of surrounding areas, optimization that comprehensively considers these is necessary. Accordingly, this disclosure proposes a methodology for performing optimization for layouts by combining neural network models using layout patterns as a medium and repeating local optimization through tile-by-tile sampling in parallel for global optimization of various characteristics for large areas.

### SUMMARY

This disclosure provides a layout optimization method with improved reliability.

This disclosure provides a layout optimization system with improved reliability.

In addition, the problems to be solved in this disclosure are not limited to the problems mentioned above, and other problems may be clearly understood by those skilled in the art from the description below.

According to an aspect of this disclosure, there is provided a layout optimization method considering spatial and physical interactions between layers, the method including defining information of a layout, deriving vulnerabilities of the layout by a vulnerability detector including a neural network model portion, performing optimization of the layout by an optimization module portion, and generating a new layout pattern by a layout database generator and updating the generated layout pattern in a layout database.

According to another aspect of this disclosure, there is provided a layout optimization method considering spatial and physical interactions between layers, the layout optimization method including defining information of a layout, deriving vulnerabilities of the layout by a vulnerability detector including a neural network model portion, performing optimization of the layout by an optimization module portion, and, by a layout database generator, generating a new layout pattern and updating the generated layout pattern in a layout database, wherein the defining of the information of the layout includes entering layout information, which is a medium of the neural network model portion, into the layout database, and entering physical measurement values and simulation values for the layout, wherein the information entered into the layout database includes at least one of line width measurement values, space size, and layout density as structural information of the layout, wherein the physical measurement values and the simulation values include values for one or more of thermal distribution characteristics, stress, and topologies, and wherein the structural information of the layout includes layout image captured by a photographing portion and stored in a storage portion.

According to another aspect of this disclosure, there is provided a layout optimization method considering spatial and physical interactions between layers, the method including defining information of a layout, deriving vulnerabilities of the layout by a vulnerability detector including a neural network model portion, performing optimization of the layout by an optimization module portion, and generating a new layout pattern by a layout database generator and updating the generated layout pattern in a layout database, wherein the defining of the information of the layout includes entering layout information, which is a medium of the neural network model portion, into the layout database, and entering physical measurement values and simulation values for the layout, wherein the information entered into the layout database includes at least one of line width measurement values, space size, and layout density as structural information of the layout, wherein the physical measurement values and the simulation values include values for one or more of thermal distribution characteristics, stress, and topologies, and wherein the structural information of the layout includes a layout image captured by a photographing portion and stored in a storage portion, wherein the deriving of the vulnerabilities of the layout includes setting criteria for detecting the vulnerabilities, performing normalization on characteristic values through data preprocessing, dividing the preprocessed data into grid cells, performing local analysis for each grid cell, performing grouping of candidate vulnerability areas through a clustering algorithm, and outputting locations of major vulnerabilities among the candidate vulnerability areas and statistical information on the locations of the major vulnerabilities, wherein the setting of the criteria for detecting the vulnerabilities includes determining that the vulnerability is present when an amount of change in the characteristic value between adjacent areas is greater than a reference value or a size of the characteristic value exceeds a threshold value, and determining that the vulnerability is not present when the amount of change in the characteristic value between the adjacent areas is less than the reference value or the size of the characteristic value does not exceed the threshold value, wherein the performing of the grouping of the candidate vulnerability areas through the clustering algorithm includes distinguishing between areas where vulnerabilities are concentrated and distributed, and setting center coordinates of a cluster to the locations of the major vulnerabilities.

### BRIEF DESCRIPTION OF THE DRAWINGS

Implementations of this disclosure will be more clearly understood from the following detailed description taken in conjunction with the accompanying drawings in which:

FIG. 1 is a conceptual diagram illustrating a deterioration of a layout that is a target of a layout optimization method according to some implementations;

FIG. 2 is a conceptual diagram schematically illustrating a layout optimization method according to some implementations;

FIG. 3 is a conceptual diagram schematically illustrating components of a layout optimization system according to some implementations;

FIG. 4 is a flowchart schematically illustrating a layout optimization method according to some implementations;

FIG. 5 is a detailed flowchart for operation S100 of FIG. 4;

FIG. 6 is a conceptual diagram including elements of operation S110 of FIG. 5;

FIG. 7 is a conceptual diagram including elements of operation S120 of FIG. 5;

FIG. 8 is a detailed flowchart for operation S200a, which is an example of operation S200 of FIG. 4;

FIG. 9 is a detailed flowchart for operation S210a of FIG. 8;

FIG. 10 is a detailed flowchart for operation S250a of FIG. 8;

FIG. 11 is a detailed flowchart for operation S200b, which is another example of operation S200 of FIG. 4;

FIG. 12 is a detailed flowchart for operation S200c, which is another example of operation S200 of FIG. 4;

FIG. 13 is a detailed flowchart for operation S210c of FIG. 12;

FIG. 14 is a detailed flowchart for operation S220c of FIG. 12;

FIG. 15 is a conceptual diagram schematically illustrating an execution process of operation S200c, which is another example of operation S200 of FIG. 4;

FIG. 16 is a detailed flowchart for operation S300 of FIG. 4; and

FIG. 17 is a detailed flowchart for operation S320 of FIG. 16.

### DETAILED DESCRIPTION

The present implementations may have various modifications and may take various forms, and some implementations are illustrated in the drawings and described in detail. However, this is not intended to limit the present implementations to a particular disclosure form. In addition, the implementations described below are merely an example, and various modifications are possible from these implementations.

Any use of examples or exemplary terms is intended merely to elaborate technical ideas and is not intended to limit the scope of this disclosure unless otherwise defined by the claims.

Unless otherwise specifically stated, in this specification, a vertical direction is defined as a Z direction, and a first horizontal direction and a second horizontal direction may each be defined as a horizontal direction perpendicular to the Z direction. The first horizontal direction may be referred to as a X direction, and the second horizontal direction may be referred to as a Y direction. Vertical level may refer to a height level along the vertical direction (Z direction). Horizontal width may refer to a length in the horizontal direction (X direction and/or Y direction), and vertical length may refer to a length in the vertical direction (Z direction).

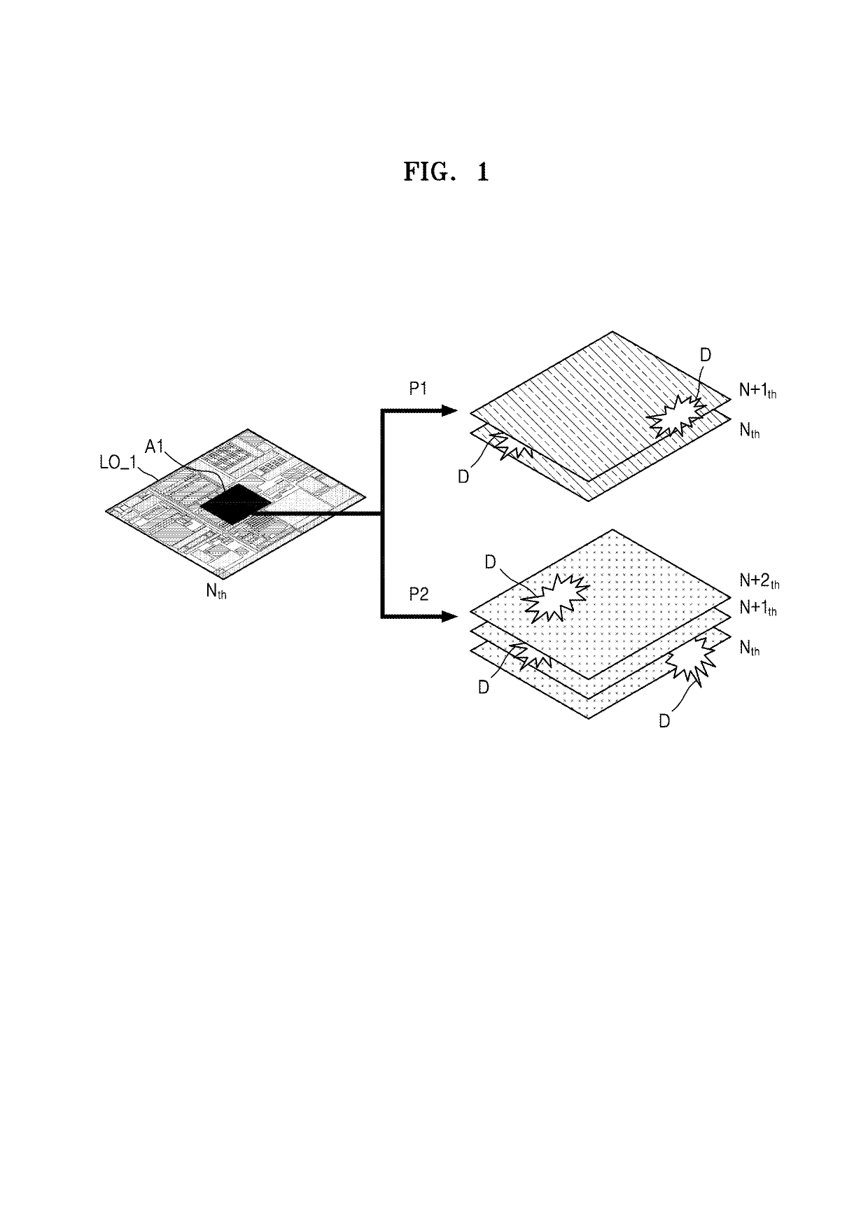

FIG. 1 is a conceptual diagram illustrating a deterioration of a layout that is a target of a layout optimization method according to some implementations.

Referring to FIG. 1, a first layout LO_1, which is the Nₜₕ layout among the layouts included in the multi-layer design consisting of a plurality of layers, is illustrated. The layout described in this disclosure may correspond to a semiconductor circuit for driving a semiconductor. Among some areas in the first layout LO_1, a first area A1 may be formed. When a design of the first area A1 is modified to improve characteristics locally, other physical characteristics of surrounding areas may deteriorate. In more detail, even if the first area A1 where a problem occurred is modified, another problem may occur in another unexpected location. This is a problem that arises when different characteristics interact with characteristics of the surrounding areas. In some implementations, a first characteristic P1 and a second characteristic P2 may deteriorate. The first characteristic P1 and the second characteristic P2 may be different characteristics from each other. The characteristics in this disclosure may include a topology, a thermal distribution characteristic, a stress, etc.

In some implementations, the first characteristic P1 may be the topology. A defect D may occur due to topological influence between the Nₜₕ layout and the (N+1)ₜₕ layout.

In some implementations, the second characteristic P2 may be the thermal distribution characteristic. The defect D may occur due to an influence of the thermal distribution characteristic between the Nₜₕ layout, the (N+1)ₜₕ layout, and the (N+2)ₜₕ layout. A modified design value for the first area A1 may be different from the first characteristic P1 and the second characteristic P2.

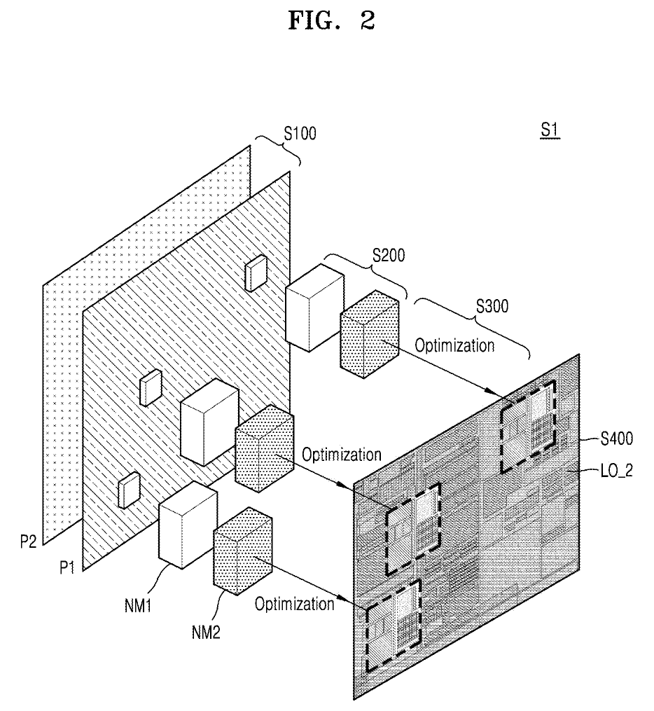

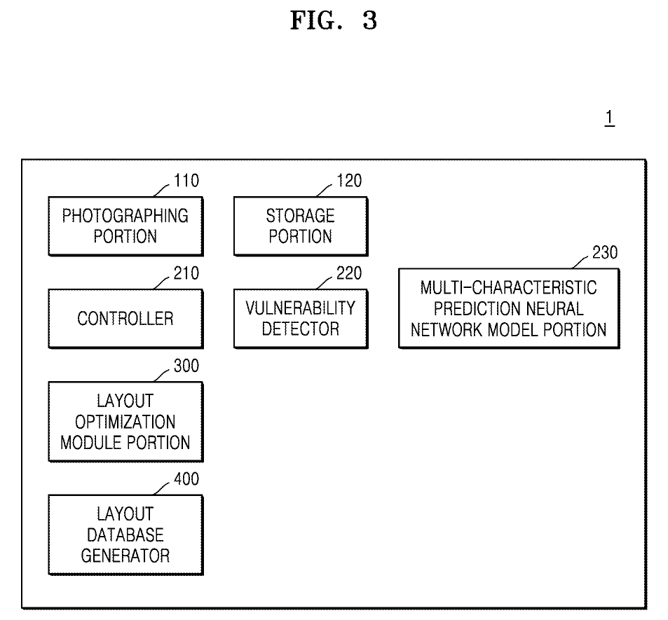

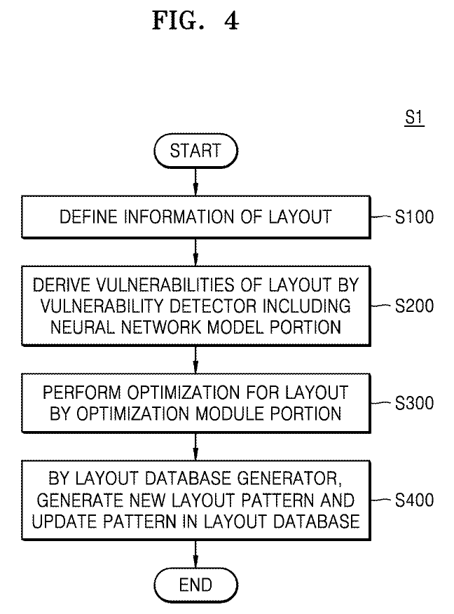

FIG. 2 is a conceptual diagram schematically illustrating a layout optimization method according to some implementations. FIG. 3 is a conceptual diagram schematically illustrating components of a layout optimization system according to some implementations. FIG. 4 is a flowchart schematically illustrating a layout optimization method according to some implementations.

FIGS. 2 - 4 are referred together. A layout optimization method S1 includes a layout optimization method that considers spatial and physical interactions between layers. According to some implementations, the layout optimization method S1 may include operation S100 of defining information of the layout. In operation S100, information on defects and performance-related issues occurring in the layout may be defined. In some implementations, in operation S100 the first characteristic P1 and the second characteristic P2 may be synthesized. A layout optimization system 1 may include a photographing portion 110 and a storage portion 120. Operation S100 may be performed by using an image captured by the photographing portion 110 and stored in the storage portion 120.

The photographing portion 110 according to some implementations may include a video camera for photographing, an image determination portion that receives an image signal from the video camera and determines whether the image signal is normal, and a data controller that receives a determination result from the image determination portion and transmits a control signal to a driver based on accumulated information, the image determining portion being installed for a close-up of the image for fine details.

The video camera includes a high-resolution differential interference camera. The differential interference contrast camera may capture images incident on a lens more clearly by applying differential interference contrast (DIC) filters, polarizing filters, and analysis filters inside an optical tube. The video camera may be a camera that captures still images or, without being limited thereto, may be a line scan camera, the line scan camera photographing a panel while an inspection table moves at a constant speed. Here, when the line scan camera is used, image data is provided by continuously photographing the layout, so that a determination operation is also processed in batches, thereby simplifying an entire processing process. Lighting may include light-emitting diodes (LEDs), and an irradiated light may have a wavelength of about 400 nm to about 500 nm. The lighting allows the camera to capture clearer images of the layout.

The image determination portion may include an image input portion receiving an image from the camera, a lighting controller connected to the lighting and controlling and transmitting a driving control signal for the lighting, an image storage portion storing an image input from the camera to the image input portion, and an algorithm execution portion configured to detect a position and order of a layout based on an algorithm from the image received from the image input portion.

The data controller may be configured to transmit the control signal to the driver based on information received and accumulated from the image determination portion. The data controller may include, for example, a machine analysis and re-engineering system (MARS).

According to some implementations, the layout optimization method S1 may include operation S200 for deriving vulnerabilities in the layout, which is performed after operation S100. Operation S200 may be performed by a vulnerability detector 220 included in the layout optimization system 1. The vulnerability detector 220 may include a multi-characteristic prediction neural network model portion 230 that predicts multiple characteristics. The method of synthesizing the characteristics and selecting the characteristics to be optimized may be performed by a controller 210 included in the layout optimization system 1. The controller 210 may perform preprocessing on the image obtained by photographing the layout. The multi-characteristic prediction neural network model portion 230 may include a plurality of models. As an example, the multi-characteristic prediction neural network model portion 230 may include a first neural network model NM1 and a second neural network model NM2. The first neural network model NM1 and the second neural network model NM2 may be combined in series and performed sequentially, or combined in parallel and performed simultaneously. When the first neural network model NM1 is combined in series with the second neural network model NM2, a data distribution of the model performed first may be propagated to the model performed later. When the first neural network model NM1 is combined in parallel with the second neural network model NM2, the data distributions of each model may not affect each other.

According to some implementations, the layout optimization method S1 may include operation S300 for performing optimization on the layout, which is performed after operation S200. Operation S300 may be performed by a layout optimization module portion 300 included in the layout optimization system 1. The layout optimization module portion 300 may perform operation S300 for each tile. That is, in operation S300, a local optimization may also be performed based on a tile-by-tile sampling.

According to some implementations, the layout optimization method S1 may include operation S400 of generating a new layout pattern and updating the new pattern in a layout database, which is performed after operation S300. Operation S400 may be performed by a layout database generator 400 included in the layout optimization system 1. A result value of operation S400 may be a second layout LO_2 in which tiles obtained by performing local optimization in operation S300 are merged. That is, operation S300 may be repeatedly performed in parallel for some areas of the second layout LO_2.

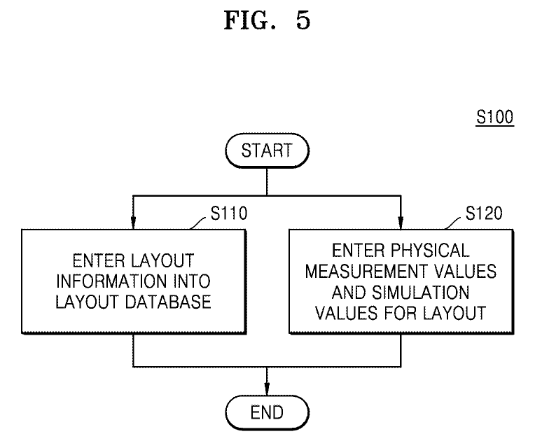

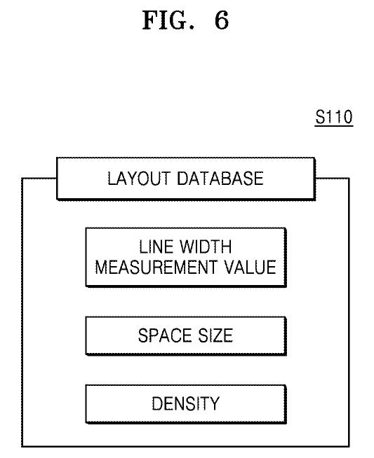

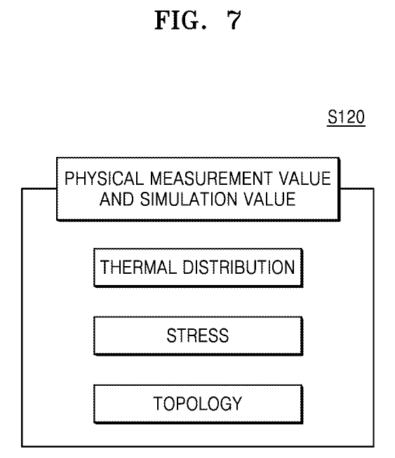

FIG. 5 is a detailed flowchart for operation S100 of FIG. 4. FIG. 6 is a conceptual diagram including elements of operation S110 of FIG. 5. FIG. 7 is a conceptual diagram including elements of operation S120 of FIG. 5.

FIGS. 5 - 7 are referred together with FIGS. 1 - 4. Operation S100 of defining information of the layout may include operation S110 of entering layout information into the layout database and operation S120 of entering physical measurement values and simulation values for the layout.

The information input in operation S110 may be large-scale layout data input into the layout database and may include information on the layout of a specific area of a semiconductor design. As an example, the specific area may have a size of about 10 μm × about 10 μm. Data input into the layout database may include structural information of the layout and information on a surrounding area. In some implementations, information stored in the layout database may include circuit patterns, line width measurements, space sizes, densities, and the like. The input information may be defined to reflect the characteristics of a multi-layer design consisting of a plurality of layers.

The physical measurement values and the simulation values which are input in operation S120 include a plurality of physical measurement values obtained during a manufacturing process. In some implementations, the physical measurements and the simulation values may include thermal distribution characteristics, stresses, topologies, etc. Data input in operation S120 may be used to train or verify the model in subsequent operations. That is, layout data input into the layout database may include structural information, and physical measurements and simulation data may include physical characteristics.

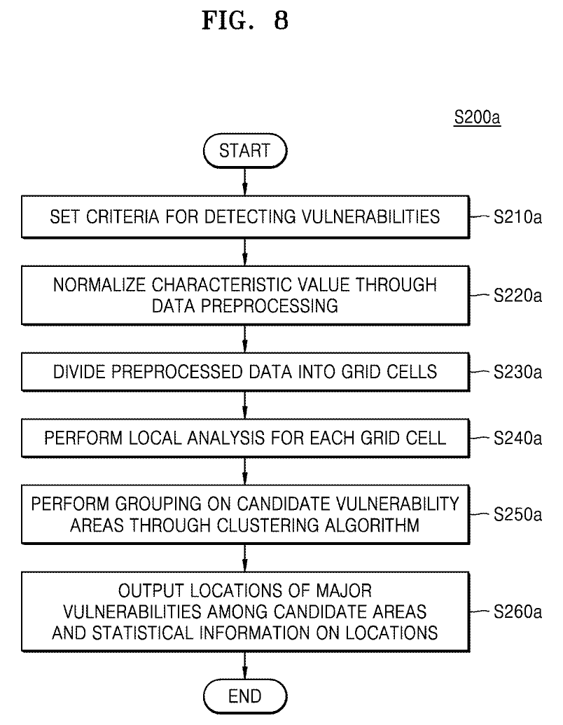

FIG. 8 is a detailed flowchart for operation S200a, which is an example of operation S200 of FIG. 4.

FIG. 8 is referred together with FIGS. 1 - 7. Operation S200a of deriving the vulnerabilities in the layout may be performed by the vulnerability detector 220. Operation S200a may correspond to some implementations of operation S200. The vulnerability detector 220 performing operation S200a may predict and analyze the characteristics of the entire chip based on the layout data input in operation S100. Afterwards, the vulnerability detector 220 may identify problems that may occur in a specific area and isolate locations of major vulnerabilities. The specific area where identification is performed by the vulnerability detector 220 may correspond to the first area A1 described above. The process of isolating the locations of the major vulnerabilities may be performed through a process of analyzing a size and amount of change of characteristic values, and the major vulnerabilities may be derived by utilizing clustering techniques.

Operation S200a may include operation S210a which sets criteria for detecting the vulnerabilities. A reference value may be set in the controller 210 The reference value set in the controller 210 may be set differently depending on a type of semiconductor layout.

Operation S200a may include operation S220a of performing characteristic value normalization through data preprocessing performed after operation S210a, and operation S230a of dividing data preprocessed in operation S220a into grid cells.

Operation S200a may include operation S240a of performing local analysis for each grid cell divided in operation S230a. Operation S240a may perform transformation on large-scale data into each grid cell so that local analysis is possible. Operation S200a may include operation S250a of performing grouping on candidate vulnerability areas through a clustering algorithm after performing division and local analysis on preprocessed data. The clustering algorithm used in operation S250a may include K-means, density-based spatial clustering of application with noise (DBSCAN), and hierarchical clustering, as examples, but the clustering algorithm is not limited thereto. Finally, operation S200a may include operation S260a of outputting the locations of the major vulnerabilities among the candidate areas grouped in operation S250a and statistical information on the locations. The results derived in operation S260a may be input into a characteristic prediction model and a density optimization module in operations described below and used to solve and improve layout problems.

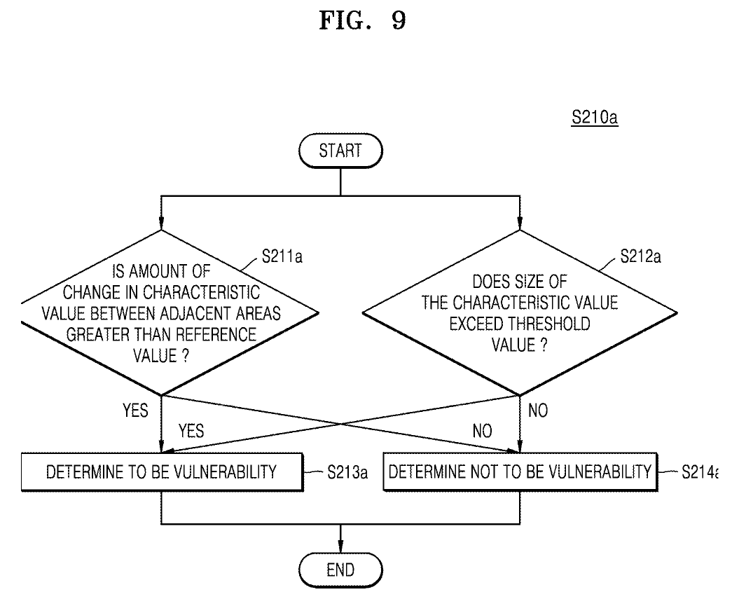

FIG. 9 is a detailed flowchart for operation S210a of FIG. 8.

FIG. 9 is described with reference to FIGS. 1 - 8. Referring to FIG. 9, operation S210a may be determined as a vulnerability or not through two determination processes.

In some implementations, operation S210a, which is an operation of setting a criterion for detecting the vulnerability, may include operation S211a of determining whether an amount of change in the characteristic value between adjacent areas is greater than the reference value, and operation S212a of determining whether a size of the characteristic value exceeds a threshold value. As described above, the reference value and the threshold value may be determined by the controller 210.

In some implementations, operation S210a may determine that the vulnerability exists in operation S213a when the amount of change in the characteristic value between adjacent areas is greater than the reference value and may determine that the vulnerability does not exist in operation S214a when the amount of change in the characteristic value between adjacent areas is less than (or less than or equal to) the reference value.

In some implementations, operation S210a may determine that the vulnerability exists in operation S213a when the size of the characteristic value exceeds the threshold value and may determine that the vulnerability does not exist in operation S214a when the size of the characteristic value does not exceed the threshold value. For example, when a topology value exceeds a process tolerance or a thermal distribution characteristic value changes abruptly in a specific direction, operation S210a may determine that the vulnerability exists. An area of the vulnerability may be a partial area or an entire area of an entire layout. The area of the vulnerability may be less than or equal to the entire area of the entire layout.

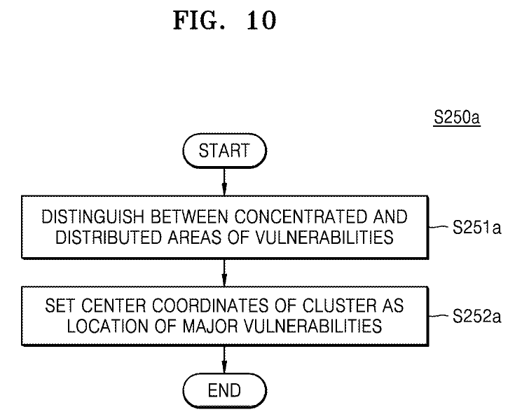

FIG. 10 is a detailed flowchart for operation S250a of FIG. 8.

Referring to FIG. 10 together with FIGS. 1 - 9, operation S250a of performing grouping of the candidate vulnerability areas through the clustering algorithm may include operation S251a of distinguishing between areas where the vulnerabilities are concentrated and areas where the vulnerabilities are distributed, and operation S252a of setting center coordinates of the clusters as the locations of the major vulnerabilities.

As a result, in operation S200a including operation S250a, the locations of the major vulnerabilities and characteristic statistical information such as an average value, maximum value, and change amount of the locations of the major vulnerabilities are finally output. In addition, results derived from operation S200a are provided together with cluster information and center point coordinates so that they may be utilized in the optimization process in subsequent operations. By recording the characteristic values within a cluster and a statistic value of the amount of change together, a severity of the deterioration in the corresponding area may be evaluated.

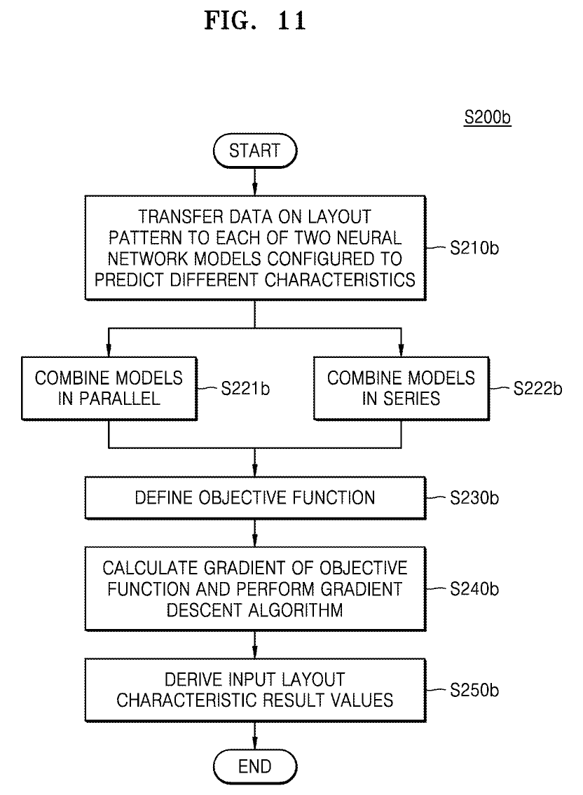

FIG. 11 is a detailed flowchart for operation S200b, which is another example of operation S200 of FIG. 4.

FIG. 11 is referred together with FIGS. 1 - 7. Operation S200b of deriving the vulnerabilities in the layout may be performed by the multi-characteristic prediction neural network model portion 230. Operation S200b may correspond to some implementations of operation S200.

In operation S200b, a model uncertainty may be considered together with a data uncertainty to effectively detect a defect probability and spatially vulnerable areas. To quantify the model uncertainty, the data distribution and the model distribution may be estimated simultaneously. These are described below in detail.

Operation S200b may include operation S210b of transferring data on a layout pattern to each of the two neural network models. The two neural network models received through operation S210b may be configured to predict different characteristics.

The two neural network models may be combined in parallel depending on operation S221b, or in series depending on operation S222b. The two neural network models may correspond to the first neural network model NM1 and the second neural network model NM2 of FIG. 2.

When the two neural network models are combined in parallel through operation S221b, data distributions of result values of each model may not affect each other. Therefore, each of the two models may be performed independently without being influenced by the result values of each other. For example, when the two models are combined in parallel, it is possible to simultaneously reflect various characteristics and efficiently obtain target values for high-dimensional data. That is, when two neural network models are combined in parallel, the two models may be executed simultaneously.

When the two neural network models are combined in series through operation S222b, the data distributions of result values of each model may affect each other. Therefore, of the two models, the model that is performed first may be performed independently. The model performed later may be operated while receiving the distribution of the previously performed model. Operation S200b may include operation S230b of defining an objective function after predicting different characteristics by combining two neural network models. By defining the objective function in operation S230b, optimal input layout characteristics may be indexed. In some implementations, the input layout characteristics may include a density or pattern of the layout.

In some implementations, operation S200b may include operation S240b of calculating a gradient of the objective function and performing a gradient descent algorithm, which is performed after operation S230b. The gradient descent algorithm of operation S240b is one of techniques used to solve optimization problems and may correspond to a method for finding a minimum value of a given function. The cost function (or loss function) in deep learning may be minimized by training the neural network model using the gradient descent algorithm.

The gradient descent algorithm in this disclosure assumes finding a parameter θ that minimizes f(θ) in the presence of f(θ). Gradient descent method may be a method that gradually moves to the optimal θ value by using the gradient of the function. An operating principle of the gradient descent method may be the same as the operating principle of a commonly used gradient descent method.

The gradient descent method used in this disclosure may include batch gradient descent method (BGD), stochastic gradient descent method (SGD), and mini-batch gradient descent method (MBGD).

The BGD performs a single update using an entire dataset, the SGD performs an update using data one at a time, and the MBGD performs an update by dividing the dataset into small batches. A neural network used in this disclosure has a differentiable structure, so that the gradient of the objective function may be calculated and a solution may be indexed using a gradient-based optimization. The neural network of this disclosure may be configured to automatically learn relationships represented by continuous and differentiable functions.

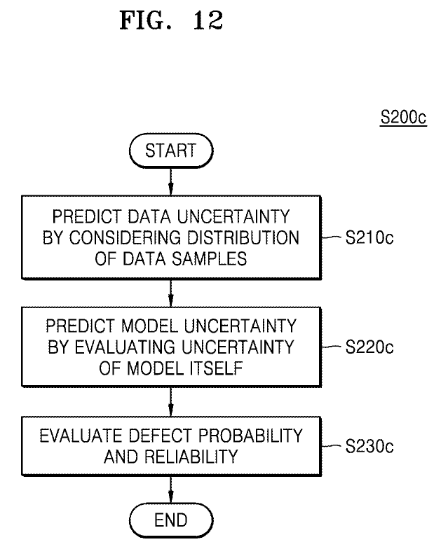

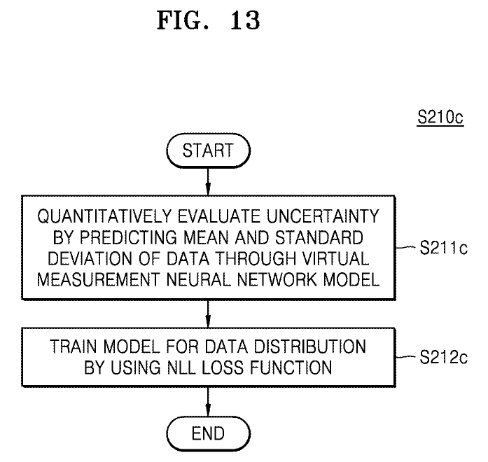

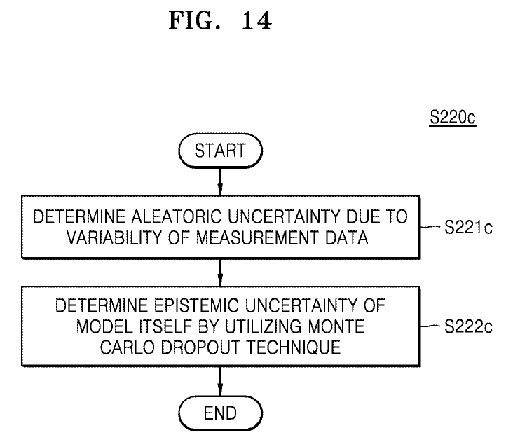

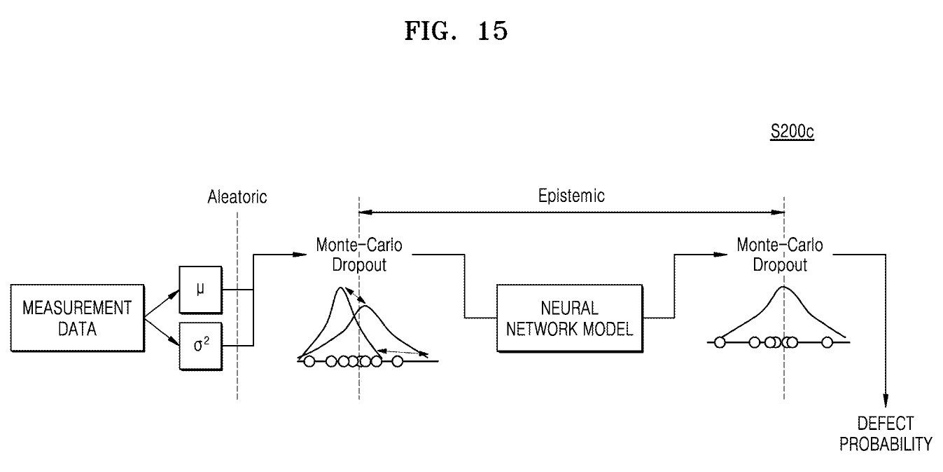

FIG. 12 is a detailed flowchart for operation S200c, which is another example of operation S200 of FIG. 4. FIG. 13 is a detailed flowchart for operation S210c of FIG. 12. FIG. 14 is a detailed flowchart for operation S220c of FIG. 12. FIG. 15 is a conceptual diagram schematically illustrating an execution process of operation S200c, which is another example of operation S200 of FIG. 4.

FIG. 12 is referred together with FIGS. 1 - 11. Operation S200c of deriving the vulnerabilities in the layout may be performed by the vulnerability detector 220. Operation S200c may correspond to some implementations of operation S200. In operation S200c, both the data uncertainty and the model uncertainty may be considered to effectively detect the defect probability and spatial vulnerable areas of the layout. For models, a method may be adopted to simultaneously predict the data distribution and model distribution to quantify uncertainty. This is described in detail below.

Operation S200c may include operation S210c of predicting an uncertainty of data by considering a distribution of data samples, operation S220c, which is a model uncertainty prediction operation of evaluating the uncertainty of the model itself performed after operation S210c, and operation S230c of evaluating the defect probability and a reliability by synthesizing operations S210c and S220c.

In some implementations, operation S210c of predicting the uncertainty of data by considering the distribution of data samples may include operation S211c of quantitatively evaluating the uncertainty by jointly predicting a mean μ and a standard deviation σ of the data through a virtual measurement neural network model. In addition, in some implementations, operation S210c may include operation S212c of training a model for data distribution by using a negative log likelihood (NLL) loss function when performing operation S211c.

The NLL loss function of this disclosure refers to a loss function that considers negative log likelihood and corresponds to a function used to maximize a likelihood of observing specific data in a probability model.

The likelihood refers to a probability that a given data is generated from a specific probability distribution, and when the probability is log-transformed and takes a negative value thereof, it may become the NLL loss function.

In some implementations, operation S220c, which is a model uncertainty prediction operation for evaluating uncertainty of the model itself, may include operation S221c of determining uncertainty (aleatoric uncertainty) due to variability of measurement data and operation S222c of determining uncertainty (epistemic uncertainty) of the model itself by utilizing Monte Carlo Dropout technique.

The aleatoric uncertainty and the epistemic uncertainty in this disclosure correspond to an example of uncertainty considered to evaluate the reliability of prediction in a deep learning model utilizing the neural network.

The aleatoric uncertainty due to the variability of measured data is an uncertainty that arises due to the inherent variability of the data itself. The causes may be noise in the data itself, errors in measurement, or incomplete observations.

The epistemic uncertainty of the model itself is an uncertainty that arises due to the lack of information learned by the model. The causes may be a lack of data or unlearned patterns.

In more detail, the aleatoric uncertainty according to some implementations is an uncertainty that exists in the data itself and may be a type that may not be reduced even with additional learning. The aleatoric uncertainty may be characterized by noise or errors in the data, or by the possibility that certain samples may be measured differently.

Operation S221c may be performed on result values of operations S211c and S212c as in FIG. 15. However, operation S222c may be performed on both data before and after training the neural network model, as in FIG. 15. That is, by enabling dropout and repeating the predictions multiple times in a Monte Carlo manner, sampling may be performed, and ultimately, the distribution of the model may be estimated by synthesizing sampling results.

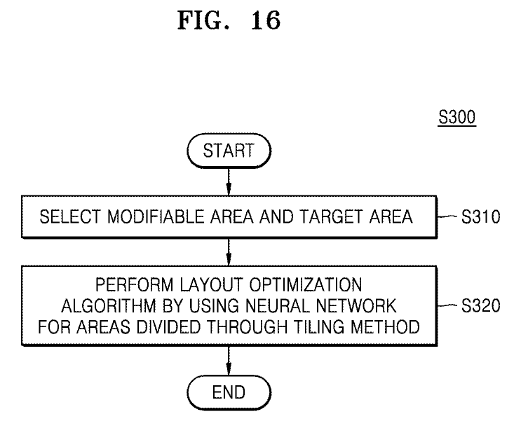

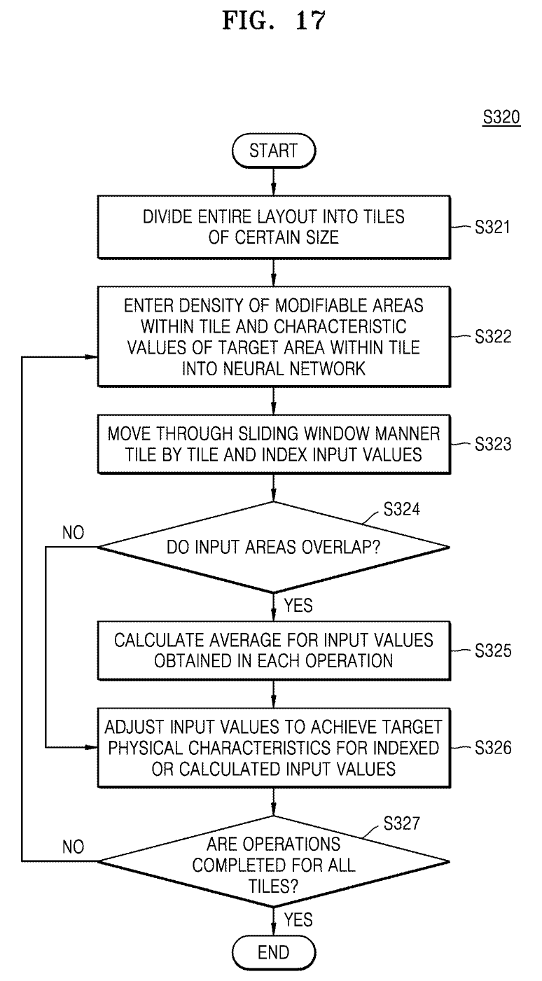

FIG. 16 is a detailed flowchart for operation S300 of FIG. 4. FIG. 17 is a detailed flowchart for operation S320 of FIG. 16.

Referring to FIGS. 16 & 17 together with FIGS. 1 - 15, operation S300 of performing optimization for the layout may include operation S310 of selecting a modifiable area and a target area, and operation S320 of performing a layout optimization algorithm by using the neural network for areas divided through a tiling method. Operation S300 may be performed by the layout optimization module portion 300 included in the layout optimization system 1.

The layout optimization module portion 300 improves the layout through operations S310 and S320 based on the large-scale layout data input in the previous operations.

The modifiable area in operation S310 is mainly the area where a dummy pattern of a circuit exists, which does not affect the existing circuit, or defines a space where a designer intentionally tries to change. In operation S310, the target area may be set as an area where specific physical characteristics are to be improved or made uniform. Specific physical characteristics of the target area may include topology and thermal distribution. Contrary to the modifiable area, the target area may be an area where an influence of physical characteristics is significant and may be designated as an area where the circuit directly operates. The modifiable area and the target area may overlap in some areas.

Referring to FIG. 17, operation S320 may include operation S321 of dividing the entire layout into tiles of a certain size (e.g., a predetermined size). This division is for processing the large-scale data. Operation S320 may include operation S322 of entering a density of the modifiable areas within the tile and characteristic values of the target area within the tile into the neural network performed after operation S321. Operation S322 corresponds to operation where the optimization may be performed independently for each tile. In this case, when the boundaries between the divided tiles are ignored, a consistency of the entire layout may be damaged, so the characteristics of surrounding tiles are reflected by setting the characteristics thereof as boundary conditions. The boundary conditions may include patterns or physical characteristics outside of each tile and may ensure a continuity and a consistency of physical characteristics between the tiles.

Operation S320 may include operation S323 of moving through a sliding window manner tile by tile after operation S322 and indexing input values to be input to each tile. Operation S320 includes operation S324 for determining whether the input areas overlap while performing operation S323. In operation S324, when the input areas overlap, operation S325 may be performed to calculate an average for the input values obtained in each operation. However, when the input areas from operation S324 do not overlap, operation S326 may be performed to adjust the input values indexed through operation S323 so as to achieve the target physical characteristics. Operation S326 may be performed similarly for the input values calculated in operation S325.

Finally, operation S327 is performed to determine whether the operations are completed for all tiles, and when the operations are not completed for all the tiles in operation S327, the operations may be performed again from operation S322.

A tile-by-tile optimization may be achieved using neural networks, and as described above, the neural networks may receive as input the density of the modifiable areas within the tile and the characteristic values of the target area within the tile. The neural networks may adjust their output to achieve target physical characteristics. In this process, the loss function makes the characteristics of the target area closer to the target value, as in operation S326, while maintaining continuity in the boundary conditions between the tiles.

The results of each tile that has been optimized may be integrated to generate the final layout, the second layout LO_2 of FIG. 2. The second layout LO_2 may be generated through operation S400. In this case, the continuity of the boundaries between tiles may be checked, and if necessary, the boundaries may be readjusted to improve the quality of the overall layout.

The algorithm for performing layout optimization in operation S300 may include, in some implementations, a large-scale prediction and optimization methodology. Large-scale prediction and optimization methodologies may take into account performance, speed, and modularity.

As an example, the large-scale prediction and optimization methodology may include local model-based convolutional integration. "local model-based convolutional integration" may refer to a method of combining local models and convolution operations to make faster and more accurate predictions over wide spaces.

Large-scale prediction and optimization methodologies may perform GPU computation by generating patches of only the coordinates of the modifiable area.

Operation S400 of FIGS. 2 - 4 may be performed by a layout database generator 400 included in the layout optimization system 1.

The layout database generator 400 may generate an actual pattern based on the density optimized through the previous operations. The actual pattern may correspond to the second layout LO_2 of FIG. 2. The actual pattern generation process may be done in conjunction with an electronic design automation (EDA) tool or in conjunction with any pattern generation solution. The layout database generator 400 may receive optimized density data as input, generate a layout pattern suitable for each manufacturing process, and ultimately update the layout database. The updated layout database may be stored in the storage portion of FIG. 4 and used as reference data when performing this disclosure again later. The updated layout data may correspond to the adjusted results from the tiling-based optimization in operation S300. That is, the updated layout data may correspond to a density value generated by uniformizing the physical characteristics of the target area and considering a continuity with the surrounding area. The density value refers to the density of the pattern to be added or adjusted in a specific space, and the pattern may only be applied within a modifiable area.

The EDA tool of the layout database generator 400 may be configured to generate an actual pattern based on the density values. The layout database generator 400 may be configured to implement optimized results by adding patterns to empty spaces or modifying existing patterns based on input density values. In this process, the layout database generator 400 may be configured to dynamically adjust the size, spacing, and arrangement of the pattern based on the density value, and to design so that no process interference occurs with existing design outside the modifiable area.

Patterns generated in this way may be verified according to design criteria to meet the requirements of the manufacturing process. Several characteristics may be considered during the verification process. In some implementations, design rules such as pattern spacing, line width, and density distribution may be applied, and ultimately, manufacturability may be confirmed. Verified results may be stored in the storage portion 120 and may be integrated into a complete layout database for use in subsequent design processes.

In some implementations, the controller 210 includes, is similar to, or is associated with, a computer system. The computer system can be configured to perform any or all operations described herein as being performed by the controller 210.

The computer system may refer to any system including a general purpose or special purpose computing system. For example, the computer system may include a personal computer, a server computer, a cloud computing system, a laptop computer, a microcontroller, and/or the like. The computer system may include at least one processor, a memory, a storage system, a network adapter, an input/output (I/O) interface, and a display. In some implementations, the computer system may lack one or more of these elements, e.g., the display. For example, the computer system can be a board-mounted microcontroller that lacks a display.

The at least one processor may execute a program module including computer system executable instructions. The program module may include routines, programs, objects, components, logic, data structures, and the like, performing a specific task or implementing a specific abstract data type. The memory (e.g., storage portion 120) may include a computer system readable, non-transitory medium in the form of a volatile memory such as a random access memory (RAM). The at least one processor may access the memory and execute instructions loaded in the memory. The storage system may non-volatilely store information and may include at least one program product including a program module configured to perform the operations described herein for the controller 210.

The network adapter may provide a connection to a local area network (LAN), a wide area network (WAN), and/or a public network (e.g., the Internet), etc. The I/O interface may provide communication channel(s) with one or more other devices, such as a peripheral device such as a keyboard, a pointing device, and/or an audio system. In some implementations, the I/O interface provides communication channel(s) to circuit system components such as IC chips, power supply, sensor(s), and/or the like. For example, the I/O interface can include a serial communication device (for example, an RS-232 port) for communicating with the other circuit system components. The display may output various pieces of information so that a user may check the information.

In some implementations, operations described above with respect to control by the controller 210, and/or the processes of FIGS. 4 - 17, are implemented as or using a computer program product. The computer program product may include a non-transitory computer-readable medium (or storage medium) including computer-readable program instructions for causing the at least one processor to perform the disclosed operations. Computer readable instructions may be, but are not limited to, assembler instructions, instruction set architecture (ISA) instructions, machine instructions, machine dependent instructions, microcode, firmware instructions, state setup data, or source code or object code written in at least one programming language.

The computer-readable medium may be any type of medium capable of non-transitorily holding and storing instructions executed by the at least one processor or any instruction executable device. The computer-readable medium may be an electronic storage device, a magnetic storage device, an optical storage device, an electromagnetic storage device, a semiconductor storage device, or any combination thereof, but is not limited thereto. For example, the computer readable medium may be a portable computer diskette, a hard disk, a random access memory (RAM), a read-only memory (ROM), an electrically erasable read only memory (EEPROM), a flash memory, a static random access memory (SRAM), a compact disc (CD), a digital versatile disc (DVD), a memory stick, a floppy disk, a mechanically encoded device such as a punch card, or any combination thereof.

While this specification contains many specific implementation details, these should not be construed as limitations on the scope of any invention or on the scope of what may be claimed, but rather as descriptions of features that may be specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations, one or more features from a combination can in some cases be excised from the combination, and the combination may be directed to a subcombination or variation of a subcombination.

While this disclosure has been particularly shown and described with reference to implementations thereof, it will be understood that various changes in form and details may be made therein without departing from the spirit and scope of the following claims.

What is claimed is:

1. A layout optimization method considering spatial and physical interactions between layers, the layout optimization method comprising:
defining information of a layout;
deriving vulnerabilities of the layout by a vulnerability detector including a neural network model portion;
performing optimization of the layout by an optimization module portion; and
generating a new layout pattern by a layout database generator and updating the generated new layout pattern in a layout database.

2. The layout optimization method of claim 1, wherein defining the information of the layout comprises:
entering layout information into the layout database; and
entering physical measurement values and simulation values for the layout.

3. The layout optimization method of claim 2, wherein the layout information entered into the layout database
includes line width measurement values, space size, and/or layout density, as structural information of the layout, and
the physical measurement values and the simulation values include one or more values of thermal distribution characteristics, stress, and/or topologies.

4. The layout optimization method of claim 1,
wherein deriving the vulnerabilities of the layout comprises:
setting criteria for detecting the vulnerabilities;
performing normalization on characteristic values through data preprocessing to produce preprocessed data;
dividing the preprocessed data into a plurality of grid cells;
performing local analysis for each grid cell of the plurality grid cells to identify candidate vulnerability areas;
performing grouping of the candidate vulnerability areas through a clustering algorithm to identify major vulnerabilities; and
outputting locations of the major vulnerabilities among the candidate vulnerability areas and statistical information on the locations of the major vulnerabilities.

5. The layout optimization method of claim 4, wherein setting the criteria for detecting the vulnerabilities comprises:
determining that a vulnerability is present based on an amount of change in a characteristic value between adjacent areas being greater than a reference value, and
determining that the vulnerability is not present based on the amount of change in the characteristic value between the adjacent areas being less than the reference value.

6. The layout optimization method of claim 4, wherein setting the criteria for detecting the vulnerabilities comprises:
determining that a vulnerability is present based on a size of a characteristic value exceeding a threshold value, and
determining that the vulnerability is not present based on the size of the characteristic value not exceeding the threshold value.

7. The layout optimization method of claim 4, wherein performing the grouping of the candidate vulnerability areas through the clustering algorithm comprises:
distinguishing between areas where vulnerabilities are concentrated and distributed; and
setting the locations of the major vulnerabilities to center coordinates of a cluster .

8. The layout optimization method of claim 4,
wherein the neural network model portion includes a multi-characteristic prediction neural network model portion including a first model and a second model that is different from the first model,
wherein setting the criteria for detecting the vulnerabilities comprises:
transferring data on the layout pattern to each of the first model and the second model, wherein the first model and the second model are configured to predict different characteristics;
processing the data on the layout pattern by combining the first model and the second model in series or in parallel;
defining an objective function;
calculating a gradient of the objective function and performing a gradient descent algorithm; and
deriving characteristic result values of an input layout,
and
wherein during serial combination of the first model and the second model, the second model is performed after the first model is performed, and a data distribution of the first model is propagated to the second model.

9. The layout optimization method of claim 1, wherein deriving the vulnerabilities of the layout comprises:
predicting data uncertainty values based on a distribution of data samples;
predicting model uncertainty values based on an uncertainty of a model of the neural network model portion; and
evaluating a defect probability and a reliability by synthesizing predicted data uncertainty values and model uncertainty values.

10. The layout optimization method of claim 9, wherein predicting the data uncertainty values comprises:
predicting a mean and a standard deviation of data through a virtual measurement neural network model to obtain the data uncertainty values; and
training the model for a data distribution based on a negative log likelihood (NLL) loss function.

11. The layout optimization method of claim 9, wherein predicting the model uncertainty values comprises:
determining an aleatoric uncertainty due to variability of measurement data; and
determining an epistemic uncertainty of the model based on a Monte Carlo Dropout technique.

12. The layout optimization method of claim 1, wherein performing the optimization of the layout by the optimization module portion comprises:
selecting a modifiable area and a target area; and
performing an optimization algorithm for the layout by utilizing a neural network for an area divided by a tiling method.

13. The layout optimization method of claim 12, wherein performing the optimization algorithm comprises:
dividing an entirety of the layout into a plurality of tiles of a predetermined size;
for each tile of the plurality of tiles, entering a density of the modifiable area within the tile and a characteristic value of the target area within the tile into the neural network;
indexing input values by moving through a sliding window method for each tile of the plurality of tiles;
determining whether input areas overlap;
based on the input areas overlapping, calculating an average for the input values obtained from each operation, or
based on the input areas not overlapping, adjusting the input values to achieve targeted physical characteristics for the indexed or calculated input values; and
determining whether the operations of the method are performed on all tiles.

14. A layout optimization method considering spatial and physical interactions among layers, the layout optimization method comprising:
defining information of a layout;
deriving vulnerabilities of the layout by a vulnerability detector that includes a neural network model portion;
performing optimization of the layout by an optimization module portion; and
generating, by a layout database generator, a new layout pattern and updating the new layout pattern in a layout database,
wherein defining the information of the layout comprises entering layout information into the layout database; and
entering physical measurement values and simulation values for the layout,
wherein the information entered into the layout database includes line width measurement values, space size, and/or layout density as structural information of the layout,
wherein the physical measurement values and the simulation values include values for thermal distribution characteristics, stress, and/or topologies, and
wherein the structural information of the layout includes a layout image captured by a photographing portion and stored in a storage portion.

15. The layout optimization method of claim 14,
wherein deriving the vulnerabilities of the layout comprises:
setting criteria for detecting the vulnerabilities;
performing normalization on characteristic values through data preprocessing to obtain preprocessed data;
dividing the preprocessed data into a plurality of grid cells;
performing local analysis for each grid cell of the plurality of grid cells to identify candidate vulnerability areas;
performing grouping of the candidate vulnerability areas through a clustering algorithm to identify major vulnerabilities; and
outputting locations of the major vulnerabilities among the candidate vulnerability areas and statistical information on the locations of the major vulnerabilities,
wherein setting the criteria for detecting the vulnerabilities comprises
determining that a vulnerability is present based on an amount of change in a characteristic value between adjacent areas being greater than a reference value or a size of the characteristic value exceeding a threshold value, and
determining that the vulnerability is not present based on the amount of change in the characteristic value between the adjacent areas being less than the reference value or the size of the characteristic value not exceeding the threshold value,
wherein performing the grouping of the candidate vulnerability areas through the clustering algorithm comprises
distinguishing between areas where vulnerabilities are concentrated and distributed; and
setting the locations of the major vulnerabilities to center coordinates of a cluster.

16. The layout optimization method of claim 14,
wherein the neural network model portion includes a multi-characteristic prediction neural network model portion comprising a first model and a second model that is different from the first model, wherein the first model is configured to predict different characteristics from the second model,
wherein deriving the vulnerabilities of the layout comprises
transferring data on the new layout pattern to each of the first model and the second model;
processing the data on the new layout pattern by combining the first model and the second model;
defining an objective function;
calculating a gradient of the objective function and performing a gradient descent algorithm; and
deriving characteristic result values of an input layout,
and
wherein, during serial combining of the first model and the second model, the second model is performed after the first model is performed, and a data distribution of the first model is propagated to the second model.

17. The layout optimization method of claim 14,
wherein deriving the vulnerabilities of the layout comprises:
predicting data uncertainty values based on a distribution of data samples;
predicting model uncertainty values by evaluating uncertainty of a model of the neural network model portion; and
evaluating a probability of defects and a reliability by synthesizing predicted data uncertainty values and model uncertainty values,
wherein predicting data uncertainty values comprises
quantitatively evaluating the uncertainty by predicting a mean and a standard deviation of data through a virtual measurement neural network model; and
training the model for a data distribution based on a negative log likelihood (NLL) loss function,
wherein predicting model uncertainty comprises
determining aleatoric uncertainty due to a variability of measurement data; and
determining epistemic uncertainty of the model based on a Monte Carlo Dropout technique.

18. The layout optimization method of claim 14,
wherein performing the optimization of the layout by the optimization module portion comprises:
selecting a modifiable area and a target area; and
performing an optimization algorithm for the layout by utilizing a neural network,
wherein performing the optimization algorithm comprises
dividing an entirety of the layout into a plurality of tiles of a predetermined size,
for each tile of the plurality of tiles, entering a density of the modifiable area within the tile and a characteristic value of the target area within the tile into the neural network,
indexing input values by moving through a sliding window method for each tile of the plurality of tiles,
determining whether input areas overlap,
calculating, based on the input areas overlapping, an average for the input values obtained from each operation, or adjusting, based on the input areas not overlapping, the input values to achieve targeted physical characteristics for the indexed or calculated input values, and
determining whether the operations of the method are performed on all tiles.

19. A layout optimization method considering spatial and physical interactions between layers, the layout optimization method comprising:
defining information of a layout;
deriving vulnerabilities of the layout by a vulnerability detector including a neural network model portion;
performing optimization of the layout by an optimization module portion; and
generating a new layout pattern by a layout database generator and updating the generated new layout pattern in a layout database,
wherein defining the information of the layout comprises
entering layout information into the layout database, and
entering physical measurement values and simulation values for the layout,
wherein the layout information entered into the layout database comprises line width measurement values, space size, and/or a layout density as structural information of the layout,
wherein the physical measurement values and the simulation values comprise thermal distribution characteristics, stress, and/or topologies, and
wherein the structural information of the layout includes a layout image captured by a photographing portion and stored in a storage portion,
wherein deriving the vulnerabilities of the layout comprises
setting criteria for detecting the vulnerabilities,
performing normalization on characteristic values through data preprocessing to obtain preprocessed data,
dividing the preprocessed data into a plurality of grid cells,
performing local analysis for each grid cell of the plurality of grid cells to identify candidate vulnerability areas,
performing grouping of the candidate vulnerability areas through a clustering algorithm to identify major vulnerabilities, and
outputting locations of the major vulnerabilities among the candidate vulnerability areas and statistical information on the locations of the major vulnerabilities,
wherein setting the criteria for detecting the vulnerabilities comprises determining that a vulnerability is present based on an amount of change in a characteristic value between adjacent areas being greater than a reference value or a size of the characteristic value exceeding a threshold value, and
determining that the vulnerability is not present based on the amount of change in the characteristic value between the adjacent areas being less than the reference value or the size of the characteristic value not exceeding the threshold value,
wherein performing the grouping of the candidate vulnerability areas through the clustering algorithm comprises
distinguishing between areas where vulnerabilities are concentrated and distributed, and
setting the locations of the major vulnerabilities to center coordinates of a cluster.

20. The layout optimization method of claim 19,
wherein the neural network model portion includes a multi-characteristic prediction neural network model portion including a first model and a second model that is different from the first model, wherein the each of the first model and the second model is configured to predict different characteristics,
wherein deriving the vulnerabilities of the layout comprises:
transferring data on the new layout pattern to each of the first model and the second;
processing the data on the new layout pattern by combining the first model and the second model;
defining an objective function;
calculating a gradient of the objective function and performing a gradient descent algorithm; and
deriving characteristic result values of an input layout,
wherein combining the first model and the second model is performed either in series or in parallel, and
wherein, during serial combination of the first model and the second model, the second model is performed after the first model is performed, and a data distribution of the first model is propagated to the second model,
wherein the performing of the optimization of the layout by the optimization module portion comprises
selecting a modifiable area and a target area, and
performing an optimization algorithm for the layout by utilizing a neural network for an area divided by a tiling method,
wherein performing the optimization algorithm for the layout by utilizing the neural network for the area divided by the tiling method comprises
dividing an entirety of the layout into a plurality of tiles of a predetermined size,
for each tile of the plurality of tiles, entering a density of the modifiable area within the tile and a characteristic value of the target area within the tile into the neural network,
indexing input values by moving through a sliding window method for each tile of the plurality of tiles,
determining whether input areas overlap,
calculating, based on the input areas overlapping, an average for the input values obtained from each operation, or adjusting, based on the input areas not overlapping, the input values to achieve targeted physical characteristics for the indexed or calculated input values, and
determining whether the operations of the method are performed on all tiles.
